(19) United States
(12) Patent Application Publication
(10) Pub. No.: US 2021/0101591 A1
(43) Pub. Date: Apr. 8, 2021

(54) SYSTEM AND METHOD FOR LOWERING RISK DURING OPERATION OF A MOVING VEHICLE

(71) Applicant: HAROLD PEDROZA, CALI (CO)

(72) Inventor: HAROLD PEDROZA, CALI (CO)

(73) Assignee: NAVISAF S.A.S, CALI (CO)

(21) Appl. No.: 16/590,410

(22) Filed: Oct. 2, 2019

(51) Int. Cl. B60W 30/095; G01S 19/42; B60W 40/09; G08G 1/16

(52) U.S. Cl. CPC B60W 30/0956; G01S 19/42; B60W 40/09; B60W 2050/046; B60W 2750/40; B60W 2550/408; B60W 2530/14; G08G 1/161

(57) ABSTRACT

The present invention provides a system and method to minimize the occurrence of mishaps and accidents of a target moving vehicle on a road, the target moving vehicle is assisted with operational instructions from a computer server by means of communication of the computer server with at least one communicating device in the target moving vehicle, where the operational instructions are originated from the computer server calculations of risk levels, wherein the risk levels are derived from data received by the computer server, wherein the data received by the computer server comprises data from at least one communicating device in the target moving vehicle itself; data from road conditions real time databases describing the road area conditions where the target moving vehicle is operating; data from, for example, real time weather databases describing the environmental conditions of the location where the target vehicle is operating; data from maintenance databases describing the mechanical conditions and equipment of the target moving vehicle and at least of the one other moving vehicle operating in proximity to the target moving vehicle; data from at least another communication device in at least one other vehicle operating in proximity of the target moving vehicle; and data from driving and profile record databases describing the driving and profile records of the driver of at least one other moving vehicle operating in proximity of the target moving vehicle.

### BACKGROUND OF THE INVENTION

### 1. Field of the Invention

The present invention is related to a system for lowering risk during operation of a moving vehicle on a road, wherein the system by means of a computer server send instructions to the moving vehicle during the operation of the moving vehicle according to risk levels calculated from real time data obtained from a communication device or devices in the moving vehicle itself, from other communicating device or devices in other moving vehicle or vehicles operating in close proximity on the same road, from road and environmental condition databases corresponding to the road where the moving vehicle is operating, from the moving vehicle and the other moving vehicle maintenance and equipment record databases, from databases providing the driving and profile records of the driver of the moving vehicle and the driver or drivers the other moving vehicle or vehicles, wherein the instructions are send from the computer server to a communication device or devices in the moving vehicle, and wherein following the instructions results in reducing the risk levels during the operation of the moving vehicle, therefore, minimizing the occurrence of mishaps and accidents of the moving vehicle itself, and, of the moving vehicle and the other moving vehicle or vehicles.

### 2. Description of Prior Art

To address the perennial need to reduce mishaps and accidents on roads, there are many described methods and systems based on advances in data communication technology to assist the operation of road moving vehicles. However, there is no description of a system providing assistance to road moving vehicles wherein the target moving vehicle to be assisted receives operating instructions that will minimized risk generated by, for example, inadequate mechanical conditions and or inadequate mechanical operating equipment of other moving vehicles operating in proximity of the target moving vehicle.

The present invention provides a system that assist the safe operation of a target moving vehicle on a road by assessing the risk generated by the operation of the target moving vehicle itself, the risk generated by the road condition and the road environmental conditions, and the risk generated by the other moving vehicles being operated in close proximity of the target moving vehicle.

### SUMMARY OF THE INVENTION

The present invention provides a system and method to minimize the occurrence of mishaps and accidents of a target moving vehicle on a road, the target moving vehicle is assisted with operational instructions from a computer server by means of communication of the computer server with at least one communicating device in the target moving vehicle, where the operational instructions are originated from the computer server calculations of risk levels, wherein the risk levels are derived from data received by the computer server, wherein the data received by the computer server comprises data from at least one communicating device in the target moving vehicle itself; data from road conditions real time databases describing the road area conditions where the target moving vehicle is operating; data from, for example, real time weather databases describing the environmental conditions of the location where the target vehicle is operating; data from maintenance databases describing the mechanical conditions and equipment of the target moving vehicle and at least of the one other moving vehicle operating in proximity to the target moving vehicle; data from at least another communication device in at least one other vehicle operating in proximity of the target moving vehicle; and data from driving and profile record databases describing the driving and profile records of the driver of at least one other moving vehicle operating in proximity of the target moving vehicle.

Specifically, the present invention provides a system for lowering risk during operation of a moving vehicle, comprising:
a. a server that receives multiple sources' data, wherein the received data comprises
   data describing the target moving vehicle's mechanical and equipment conditions and the target moving vehicle's operation;
   data describing a least one other moving vehicle's mechanical and equipment conditions and the other moving vehicle's operation, wherein the one other vehicle is operating in proximity to the target moving vehicle;
   data describing the environmental conditions of the road area where the target moving vehicle and at least the one other moving vehicle in proximity to the target moving vehicle are operating data describing the road conditions where the target moving vehicle and at least the one other moving vehicle operating in proximity to the target moving vehicle are operating;
   data describing the mechanical and equipment conditions of the target moving vehicle, wherein this data describing the mechanical and equipment conditions of the target moving vehicle is at least about the condition and specifications of the tires of the target moving vehicle;
   data describing the mechanical and equipment conditions of at least the one other moving vehicle operating in proximity to the target moving vehicle, wherein this data describing the mechanical and equipment conditions of at least the one other moving vehicle is at least about the condition and specifications of the tires of the one other moving vehicle;
   data describing the driving record and the driving profile of the driver of the target moving vehicle;
   data describing the driving record and the driving profile of the driver of at least the one other vehicle operating in proximity to the target moving vehicle;
b. multiple sources that send the data to the server, wherein the multiple sources comprise at least one communicating dispositive in the target moving vehicle, at least another communicating dispositive in at least the one other vehicle operating in proximity to the target moving vehicle, and at least one database;

wherein the server is programmed to use the received data to calculate real time risk levels for the target moving vehicle, and for at least the one other moving vehicle operating in proximity to the target moving vehicle;

wherein the server, based on the calculated real time risk levels, sends to the at least one communicating dispositive in the target moving vehicle operational instructions to assist in the operation of the target moving vehicle.

### BRIEF DESCRIPTION OF THE DRAWINGS

FIG. 1. shows an illustration of an embodiment of the system of the present invention wherein the flow of information data is indicated, by means of dotted lines with one arrow at one end, from a target moving vehicle (010) and at least one other moving vehicle (020) to databases with the moving vehicles' maintenance, mechanical, and equipment (070) records, and to databases with driving and profile (080) records, from road condition changes (090) to a moving vehicle (030) and to a database with real time road conditions (050) records, from environmental events (100) to a moving vehicle (020) and a database with real time environmental (060) records, from the databases (050, 060, 070, 080) to a computer server (040); and of information data and operational instructions, by means of dotted lines with arrows at both ends, between the computer server (040) and the moving vehicles (010, 020, 030).

FIG. 2. shows an flow chart illustration of an embodiment of the system of the present invention wherein the flow of information data is indicated, by means of solid lines with one arrow at one end, from a target moving vehicle (010) and at least one other moving vehicle (020) to databases with the moving vehicles' mechanical and equipment (070) records, and to databases with driving and profile (080) records, from road condition changes registered by a moving vehicle (030) to a database with real time road conditions (050) records, from environmental events (100) registered by a moving vehicle (020) to a database with real time environmental (060) records, from the databases (050, 060, 070, 080) to a computer server (040); and of information data and operational instructions, by means of solid lines with arrows at both ends, between the computer server (040) and the moving vehicles (010, 020, 030).

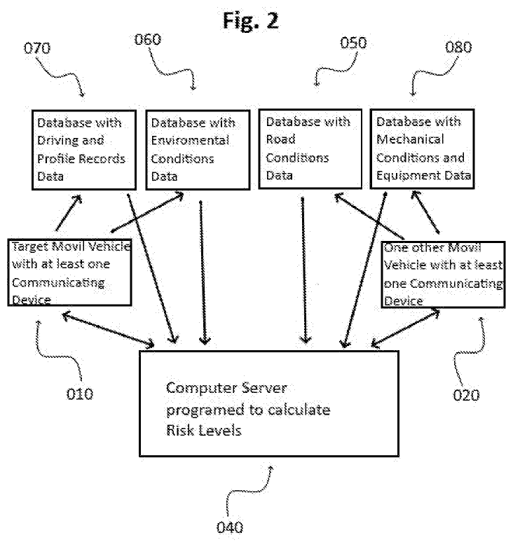

FIG. 3. shows in FIG. 3A an illustration of an example of the system of present invention wherein the computer server (040) has received data from an environmental database (060) that has registered an environmental event (100), snowing; and data from another database (070) with records of one other moving vehicle traveling in proximity of the target moving vehicle (010), wherein the records of the one other moving vehicle (020) describe year model, equipment, features, tire's condition and tire's specification; wherein the server (040), based on these received data records, sends operating instructions to a target vehicle (010). FIG. 3B shows that the target moving vehicle (010), following the instructions sent by the server (040), has moved further behind and one more highway lane away from the one other moving vehicle (020).

### DETAILED DESCRIPTION OF THE INVENTION

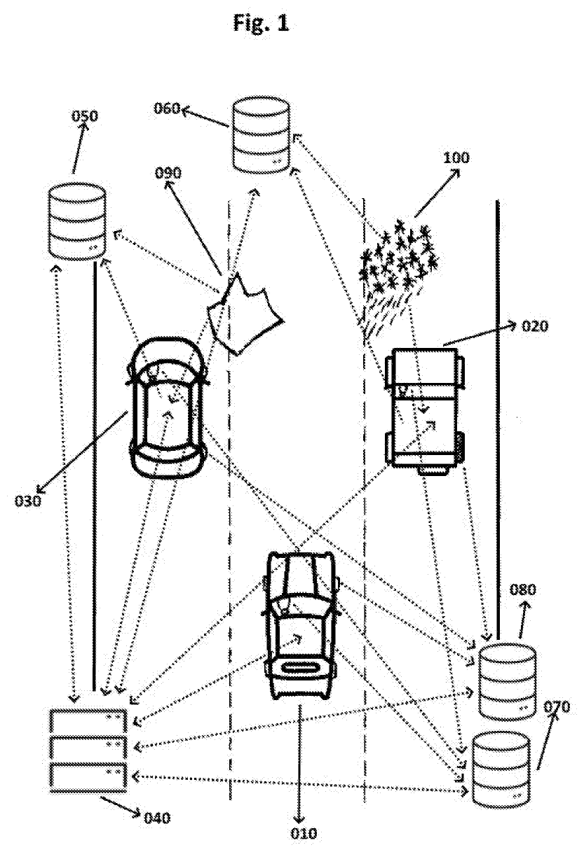

FIG. 1 shows an illustration of an embodiment of a system for lowering risk during operation of a moving vehicle, wherein the system is comprising:
a. a server (040) that receives multiple sources' data, wherein the received data comprises
   data describing the target moving vehicle's (010) mechanical and equipment conditions and the target moving vehicle's (010) operation;
   data describing a least one other moving vehicle's (020, 030) mechanical and equipment conditions and the other moving vehicle's (020, 030) operation, wherein the one other vehicle (020, 030) is operating in proximity to the target moving vehicle (010);
   data describing the environmental conditions (100) of the road area where the target moving vehicle (010) and at least the one other moving vehicle (020, 030) in proximity to the target moving vehicle (010) are operating data describing the road conditions (090) where the target moving vehicle (010) and at least the one other moving vehicle (020, 030) operating in proximity to the target moving vehicle (010) are operating;
   data describing the mechanical and equipment conditions of the target moving vehicle (010), wherein this data describing the mechanical and equipment conditions of the target moving vehicle (010) is at least about the condition and specifications of the tires of the target moving vehicle (010);
   data describing the mechanical and equipment conditions of at least the one other moving vehicle (020, 030) operating in proximity to the target moving vehicle (010), wherein this data describing the mechanical and equipment conditions of at least the one other moving vehicle (020, 030) is at least about the condition and specifications of the tires of the one other moving vehicle (020, 030);
   data describing the driving record and the driving profile of the driver of the target moving vehicle (010);
   data describing the driving record and the driving profile of the driver of at least the one other vehicle (020, 030) operating in proximity to the target moving vehicle (010);
b. multiple sources (010, 020, 030, 050, 060, 070, 080) that send the data to the server (040), wherein the multiple sources (010, 020, 030, 050, 060, 070, 080) comprise at least one communicating dispositive in the target moving vehicle (010), at least another communicating dispositive in at least the one other vehicle (020, 030) operating in proximity to the target moving vehicle (010), and at least one database (050, 060, 070, 080);

wherein the server (040) is programmed to use the received data to calculate real time risk levels for the target moving vehicle (010), and for at least the one other moving vehicle (020, 030) operating in proximity to the target moving vehicle (010);

wherein the server (040), based on the calculated real time risk levels, sends to the at least one communicating dispositive in the target moving vehicle (010) operational instructions to assist in the operation of the target moving vehicle (010).

For the purpose of the present invention a server refers to a computer server.

In one aspect of the inspection system of the present invention, the server (010) receives data from different sources (010, 020, 030, 050, 060, 070, 080) by means of the Internet of Things (IoT), wherein the IoT for the purpose of the present inventions is defined as an arrangement of sensors, geographical beacons, communicating mobile phone towers, satellites, computing devices, computer servers, communicating devices, mechanical and digital machines, objects, animals, people etc., that are provided with unique identifiers (UIDs) and the ability to transfer data from one component of the arrangement to another component of the arrangement, and over a network or networks.

The server (040) also communicates with the databases (0050, 060, 070, 080) by means of the IoT to send to the databases (0050, 060, 070, 080) data received from the target moving vehicle (010) and at least one other moving vehicle (020, 030).

For the purpose of the present invention databases refers to database servers (0050, 060, 070, 080) that record and store data communicated by means of the IoT, wherein the databases (0050, 060, 070, 080) are also part of the IoT.

A road condition database refers to a database that registers and records one or more anomaly or condition that will make the road non-optimal for moving vehicles traveling on that road, as for example, potholes, water road pools, road snow, non-road obstructing objects or bodies, persons or animals on the road, gravel road sections, roads being repaired, traffic signs, etc.

An environmental condition database refers to a database that registers and records one or more environmental or weather events that makes a road non-optimal for travel of moving vehicles on that road, as for example, raining, snowing, high winds, mist, darkness, brightness, bad visibility, etc.

A driving record and profile database refers to a database that registers and records driving, profile records, and behavior of drivers while driving a moving vehicle.

A database with moving vehicles' maintenance, mechanical, features and equipment refers to a database the registers and records one or more of the following:
moving vehicles' vin numbers,
all moving vehicles' features, as for example anti-lock brakes system (ABS), traction control, electronic stabilization, etc
moving vehicles' tire and tire specifications, and tire purchasing dates,
moving vehicles' mileage, and usage,
moving vehicles' safety inspection records,
moving vehicles' maintenance records, and
any data related to moving vehicles' maintenance, mechanical, features and equipment.

In one aspect of the inspection system of the present invention, the server (010) sends operation instructions to a communicating device or dispositive in a target moving vehicle (010) by means of the IoT. The server (010) can also send operational instructions to at least one other moving vehicle (020, 030).

For the purpose of the present invention a moving vehicle is defined as any kind of vehicle with an engine or motor with at least two wheels able to travel in a road, wherein a moving vehicle's definition comprises two-wheelers, three-wheelers, four wheelers, and so forth.

For purposes of the present invention, a communicating device or dispositive in the target moving vehicle (010) and at least one other moving vehicle (020, 030) refers to devices that includes at least one of the following:
a smartphone,
a cell mobile device,
a moving vehicle's dashboard interface,
a moving vehicle's computer,
a moving vehicle controller device, wherein the controller device controls any feature, device, mechanism for the operation of the moving vehicle, as for example, speed, gears, brakes, headlamps, windshield wipers, starter, steering, etc., and,
any other kind of the moving vehicle's communicating device enabled to communicate by means of the IoT.

Wherein the communicating device or dispositive is equipped with one or more features and components that register and record a moving vehicle's behavior, as for example Global Position System (GPS), accelerometers, gyroscopes, temperature sensors, etc.

Wherein one of the communicating device's features registers and records data originated from a moving vehicle's component sensors and moving vehicle's feature, as for example, ABS sensor, traction control sensor, suspension sensors, tire air pressure sensor, speed sensor, etc.

For the purpose of the present invention, a risk level is calculated by assigning a risk score value to a record or register that has been received as data by the server (040), wherein the risk score value assigned to a record or register germane to a target moving vehicle (010) in the road could be zero or a positive numerical value, wherein risk score values are mathematically used to calculate a risk value, wherein the calculated risk value is categorized in a scale of three risk levels, wherein the three risk levels are low risk level, moderate risk level, and high risk level.

In one more aspect of the present invention, the low risk level does not originate any instruction to change the operation of a moving vehicle; an intermediate risk level originates an instruction indicating a warning and a suggested action change in the operation of a moving vehicle since the probability of a mishap or accident is moderately increased; and a high risk level originates a strong instruction, wherein the instruction can be a strong suggestion, or obligatory instruction in order to continue with the operation of the moving vehicle and not at the moving vehicle's drivers discretion, wherein the high level of risk indicates a more imminent probability of mishap or accident.

One example of a low risk level is the risk level that has been calculated based on data received by the server (040) indicating that a road is in optimal conditions, that the environmental and weather conditions in the same road area are optimal, that the profiling and driving records of the drivers of the moving vehicles traveling in the same road do not show patterns of violations that could endanger other moving vehicles and drivers traveling in the same road, that the moving vehicles in the same road have records indicating optimal features, mechanical and equipment conditions to operate under the concurrent road and environmental conditions, and that the drivers are following all good practices, regulations and norms, e.g., speed limit, distance to car ahead, etc. required to operate the moving vehicles on the same road.

One example of a moderate risk level is the risk level that has been calculated based in data received by the server (040) indicating that a road is in optimal conditions, the environmental and weather conditions in the same road area are optimal, that the profiling and driving records of the drivers of the moving vehicles traveling in the same road do not show patterns of violations that could endanger the other moving vehicles and drivers in the same road, that the moving vehicles in the same road have records indicating optimal features, mechanical and equipment conditions to operate under the concurrent road and environmental conditions, and that the drivers of the target moving vehicle (010) is not following all good practices, regulations and norms required to operate the moving vehicles on the same road, e.g., exceeding speed limit no more than 15 miles over. In this case, the server (040) will originate a suggested instruction to the driver of the target moving vehicle (010) to reduce the speed of the car below or to same speed limit allowed for that road.

Another example of a calculated moderate risk level is the risk level that has been calculated based in data received by the server (040) indicating that a road is not in optimal conditions, e.g., sections of gravel road, pools of water on the road, and that environmental and weather conditions in the same road area are not optimal, e.g., it is raining or snowing. In this case, the server (040) will originate a suggested instruction to the driver of the target vehicle (010) to reduce the speed of the moving vehicle before the target moving vehicle (010) encounters the non-optimal road and environmental conditions.

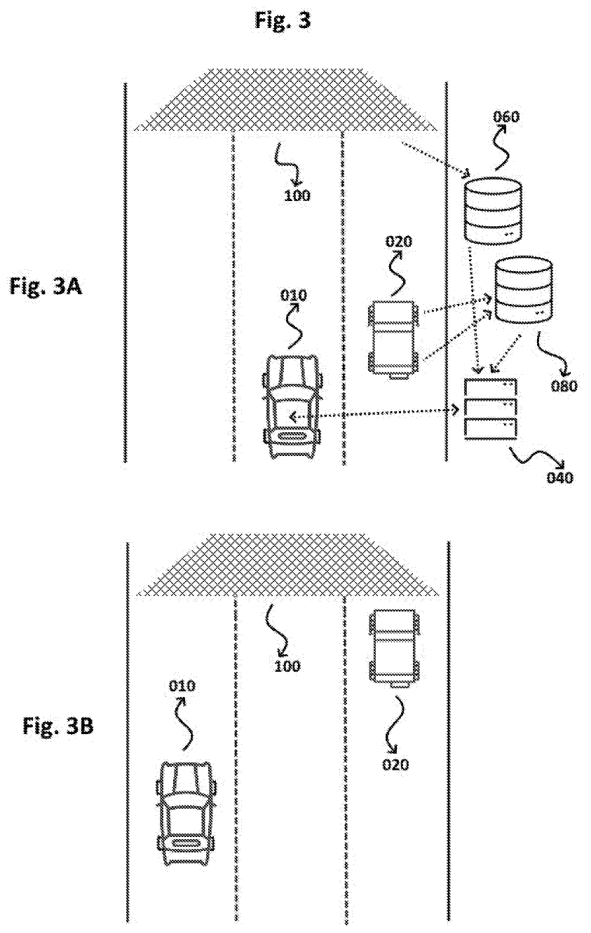

One example of a calculated high risk level is the risk level that has been calculated based in data received by the server (040) indicating that a road is not in optimal conditions, e.g., the road section is downhill, there is snow on the road, and the environmental and weather conditions in the same road area are not optimal, etc., it is snowing, that the one other moving vehicle (020) traveling in proximity of the target moving vehicle (010) is operating with, non-optimal equipment to operate when it is snowing and when there is snow on a road, e.g., non-snow slick tires, year-model without traction control and without ABS. Consequently, the server (040) will send strong instructions to the target moving vehicle (010) to move away from the vehicle with non-snow slick tires, without traction control, and without ABS (020), wherein the target moving vehicle (010), as a result of following the server's instructions, reduces speed and increases the distance away from the other moving vehicle (020) by traveling further behind in distance, and moving further one lane away from the lane where the other moving vehicle is traveling (FIGS. 3A, 3B).

For the purpose of the present invention, the data that the server (040) receives to calculate risk levels is not limited to the examples above. The data that the server (040) receives includes data indicating at least one record or register of any kind of an event, a thing, a fact, a feature, an equipment, a situation, etc. known in the art of the invention that would affect the risk of a moving vehicle traveling or operating on a road. Wherein the servers uses all kind of combinations of events, things, facts, features, situations, equipment, equipment specifications, moving vehicles' year-model etc., to calculate risk levels.

Although this description presents preferred embodiments of the present invention, additional changes may be made in the form and disposition of the parts without deviating from the ideas and basic principles encompassed by the claims.

1. A system for lowering risk during operation of a moving vehicle, comprising:
a. at least one server that receives multiple sources' data, wherein the received data comprises
data describing the target moving vehicle's mechanical and equipment conditions and the target moving vehicle's operation;
data describing a least one other moving vehicle's mechanical and equipment conditions and the other moving vehicle's operation, wherein the one other vehicle is operating in proximity to the target moving vehicle;
data describing the environmental conditions of the road area where the target moving vehicle and at least the one other moving vehicle in proximity to the target moving vehicle are operating;
data describing the road conditions where the target moving vehicle and at least the one other moving vehicle operating in proximity to the target moving vehicle are operating;
data describing the mechanical and equipment conditions of the target moving vehicle, wherein this data describing the mechanical and equipment conditions of the target moving vehicle is at least about the condition and specifications of the tires of the target moving vehicle;
data describing the mechanical and equipment conditions of at least the one other moving vehicle operating in proximity to the target moving vehicle, wherein this data describing the mechanical and equipment conditions of at least the one other moving vehicle is at least about the condition and specifications of the tires of the one other moving vehicle;
data describing the driving record and the driving profile of the driver of the target moving vehicle;
data describing the driving record and the driving profile of the driver of at least the one other vehicle operating in proximity to the target moving vehicle;
b. multiple sources that send the data to the server, wherein the multiple sources comprise at least one communicating dispositive in the target moving vehicle, at least another communicating dispositive in at least the one other vehicle operating in proximity to the target moving vehicle, and at least one database;
wherein the server is programmed to use the received data to calculate real time risk levels for the target moving vehicle, and for at least the one other moving vehicle operating in proximity to the target moving vehicle;
wherein the server, based on the calculated real time risk levels, sends to the at least one communicating dispositive in the target moving vehicle operational instructions to assist in the operation the target moving vehicle.
